(19) United States
(12) Patent Application Publication
(10) Pub. No.: US 2018/0167120 A1
(43) Pub. Date: Jun. 14, 2018

(54) ANTENNA SWITCHING

(71) Applicant: Lenovo (Beijing) Co., Ltd., Beijing (CN)

(72) Inventors: Aiguo ZHANG, Beijing (CN); Jian REN, Beijing (CN)

(21) Appl. No.: 15/782,044

(22) Filed: Oct. 12, 2017

(30) Foreign Application Priority Data
Dec. 9, 2016 (CN) 201611129478.X

(51) Int. Cl. H04B 7/06; H04B 7/08

(52) U.S. Cl. CPC H04B 7/0608; H04B 7/0689; H04B 7/0871

(57) ABSTRACT

A method includes operating an antenna of an electronic device in a first operation mode, wherein the electronic device uses a first transmission path for transmitting antenna signals, and the first transmission path includes the antenna and a first branch of a circuit coupled to the antenna; receiving a switching signal; and switching the antenna to a second operation mode based on the switching signal, wherein the electronic device uses a second transmission path for transmitting the antenna signals, and the second transmission path includes the antenna and a second branch of the circuit.

### CROSS-REFERENCE TO RELATED APPLICATION

This application claims priority to Chinese Patent Application No. 201611129478.X, filed on Dec. 9, 2016, the entire contents of which are incorporated herein by reference.

### TECHNICAL FIELD

The present disclosure generally relates to the field of antenna technologies and, more particularly, to an antenna control method and an electronic device.

### BACKGROUND

In the existing technology, a metal-frame antenna in an electronic device such as a mobile phone is generally realized by creating gaps in the metal frame. The gaps separate the antenna part. However, in some cases, as a user contacts the phone, the user may contact the gaps for signals entering. Accordingly, radio-frequency signals may be short-circuited by hand to a non-antenna portion of the frame, which is usually a ground of the mobile phone, reducing a performance of the antenna.

To prevent a hand contact from reducing the antenna performance, in most conventional technical solutions, two antennas are adopted and arranged at a top and a bottom of a mobile phone, respectively. When an unsatisfying performance due to hand contact is detected at the bottom antenna, the mobile phone switches directly to the top antenna. However, a distance between the top and the bottom of the cell phone is about approximately 150 mm. In order to transmit signals, an RF transmission line with a length of approximately 110-130 mm is needed. The transmission line can cause certain loss of signals.

### SUMMARY

In one aspect, the present disclosure provides a method. The method includes operating an antenna of an electronic device in a first operation mode, in which the electronic device uses a first transmission path for transmitting antenna signals, and the first transmission path includes the antenna and a first branch of a circuit coupled to the antenna; receiving a switching signal; and switching the antenna to a second operation mode based on the switching signal, in which the electronic device uses a second transmission path for transmitting the antenna signals, and the second transmission path includes the antenna and a second branch of the circuit.

Another aspect of the present disclosure provides another method. The method includes operating an antenna of an electronic device in a first operation mode, in which the electronic device uses a first transmission path for transmitting antenna signals, and the first transmission path includes the antenna and a first branch of a circuit coupled to the antenna; determining whether a signal performance of the antenna in the first operation mode is affected; determining a transmit power of the antenna if the signal performance of the antenna in the first operation mode is not affected; determining whether the transmit power of the antenna is greater than a power threshold; receiving a switching signal if the transmit power of the antenna is greater than the power threshold; and switching the antenna to a second operation mode based on the switching signal, in which the electronic device uses a second transmission path for transmitting the antenna signals, and the second transmission path includes the antenna and a second branch of the circuit.

In another aspect, the present disclosure provides an electronic device. The electronic device includes an antenna, a circuit coupled to the antenna, a sensor, and a controller coupled to the antenna. The circuit includes a first branch and a second branch. The sensor receives a switching signal. The controller switches the antenna from a first operation mode to a second operation mode based on the switching signal. In the first operation mode, a first transmission path including the antenna and the first branch is used for transmitting antenna signals. In the second operation mode, a second transmission path including the antenna and the second branch is used for transmitting antenna signals.

### BRIEF DESCRIPTION OF THE FIGURES

The following drawings are merely examples for illustrative purposes according to various disclosed embodiments and are not intended to limit the scope of the present disclosure.

FIG. 1 illustrates a flow chart of an exemplary antenna control method according to various disclosed embodiments of the present disclosure;

FIG. 2 illustrates a flow chart of another exemplary antenna control method according to various disclosed embodiments of the present disclosure;

FIGS. 3A and 3B illustrate schematic views of an exemplary circuit coupled to an antenna according to various disclosed embodiments of the present disclosure;

FIGS. 4A and 4B illustrate schematic views of another exemplary circuit coupled to an antenna according to various disclosed embodiments of the present disclosure;

FIG. 5 illustrates a flow chart of another exemplary antenna control method according to various disclosed embodiments of the present disclosure;

FIGS. 6A and 6B illustrate schematic views showing exemplary regions where maximum antenna radiation energy appears in an exemplary antenna control method according to various disclosed embodiments of the present disclosure; and

FIGS. 7A and 7B illustrate schematic views showing exemplary regions where maximum antenna radiation energy appears in an exemplary antenna control method according to various disclosed embodiments of the present disclosure.

### DETAILED DESCRIPTION

Embodiments of the disclosure will now be described in more detail with reference to the drawings. It is to be noted that, the following descriptions of some embodiments are presented herein for purposes of illustration and description only, and are not intended to be exhaustive or to limit the scope of the present disclosure.

The aspects and features of the present disclosure can be understood by those skilled in the art through the embodiments of the present disclosure further described in detail with reference to the accompanying drawings.

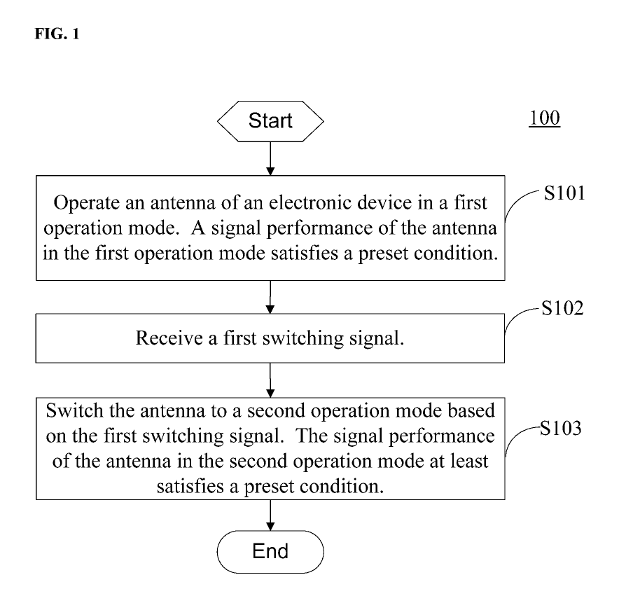

The present disclosure provides a method for controlling an antenna. FIG. 1 illustrates a flow chart of an example of antenna control method 100 according to various disclosed embodiments of the present disclosure. With reference to FIG. 1, the method 100 will now be described.

At S101, an antenna of an electronic device is operated in a first operation mode. A signal performance of the antenna in the first operation mode satisfies a preset condition.

At S102, a first switching signal is received.

At S103, the antenna is switched to a second operation mode based on the first switching signal. The signal performance of the antenna in the second operation mode at least satisfies a preset condition.

A transmission path of the antenna signal may include a first transmission path and a second transmission path. The first transmission path may include the antenna and a first branch of a circuit coupled to the antenna. The second transmission path may include the antenna and a second branch of the circuit. The antenna signal may be transmitted along the first transmission path in the first operation mode. The antenna signal may be transmitted along the second transmission path in the second operation mode.

The antenna control method of the disclosure can operate an antenna of an electronic device in a first operation mode, and switch an operation mode of the antenna from the first operation mode to a second operation mode after a first switching signal is received. The signal performance of the antenna in the first operation mode and the second operation mode can satisfy a preset condition. Further, a first transmission path of the antenna in the first operation mode may include the antenna and a first branch of a circuit coupled to the antenna. A second transmission path of the antenna in the second operation mode may include the antenna and a second branch of the circuit coupled to the antenna. In the antenna control method of the present disclosure, along the transmission paths in both operation modes, antenna signals may pass through the antenna. That is, in the present disclosure, through one antenna, the signal performance of the antenna may satisfy the preset condition, by switching the antenna operation mode, i.e., switching the transmission path of the antenna signal. The present disclosure may avoid the certain antenna signal loss caused by a transmission line, which is needed in the existing technology to switch between the top antenna and the bottom antenna of the conventional electronic device.

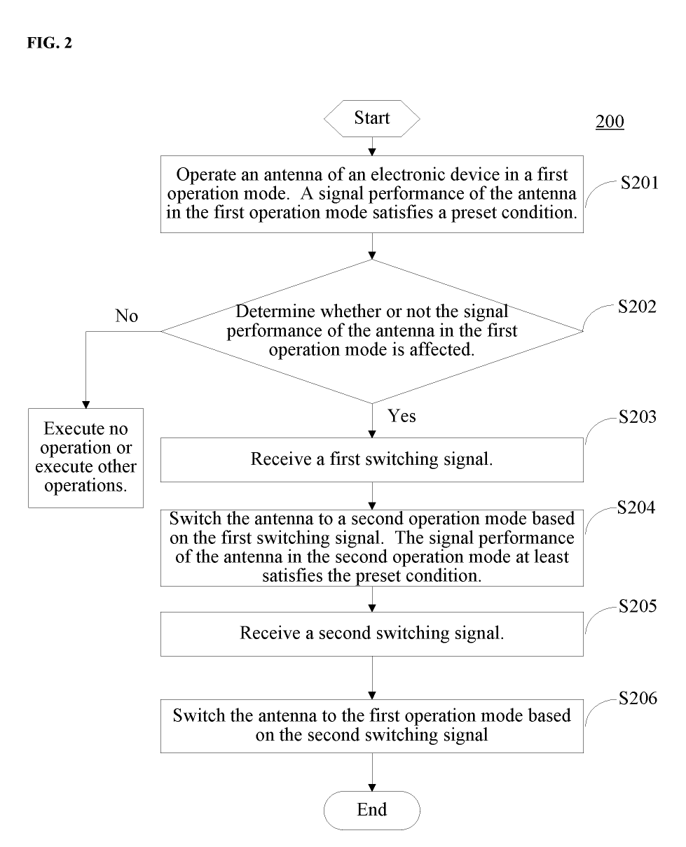

FIG. 2 illustrates a flow chart of another example of antenna control method 200 according to various disclosed embodiments of the present disclosure. With reference to FIG. 2, the method 200 will now be described.

At S201, an antenna of an electronic device is operated in a first operation mode.

A signal performance of the antenna in the first operation mode satisfies a preset condition. In some embodiments, the electronic device can be a mobile phone, and the preset condition that the signal performance can satisfy includes that the signal performance of the antenna can satisfy the need of a normal phone call.

At S202, whether or not the signal performance of the antenna in the first operation mode is affected is determined.

At S203, if the signal performance of the antenna in the first operation mode is affected, a first switching signal is received.

In some embodiments, whether or not the signal performance of the antenna in the first operation mode is affected may be determined, by determining whether or not the signal performance of the antenna in the first operation mode satisfies a preset condition. If the signal performance of the antenna in the first operation mode does not satisfy the preset condition, it may indicate that the signal performance of the antenna in the first operation mode is affected. Accordingly, the first switching signal may be received, and the operation mode of the antenna may need to be switched.

At S204, the antenna is switched to a second operation mode based on the first switching signal.

The signal performance of the antenna in the second operation mode at least satisfies the preset condition.

A transmission path of the antenna signal may include a first transmission path and a second transmission path. The first transmission path may include the antenna and a first branch of a circuit coupled to the antenna. The second transmission path may include the antenna and a second branch of the circuit. The antenna signal may be transmitted along the first transmission path in the first operation mode. The antenna signal may be transmitted along the second transmission path in the second operation mode.

At S205, after the antenna is switched to the second operation mode, a second switching signal is received.

Similarly, the receiving of the second switching signal may include determining whether the signal performance of the antenna in the second operation mode is affected, and receiving the second switching signal if the signal performance of the antenna in the second operation mode is affected. If the signal performance of the antenna in the second operation mode is affected, it may indicate that the signal performance of the antenna in the second operation mode cannot satisfy the preset condition.

At S206, the antenna is switched to the first operation mode based on the second switching signal.

The antenna control method of the present disclosure can operate an antenna of an electronic device in a first operation mode, and can receive a first switching signal and then switch to a second operation mode, in respond to that the signal performance of the antenna in the first operation mode is affected. Further, the antenna control method of the present disclosure can receive a second switching signal and then switch back to the first operation mode, in respond to that the signal performance of the antenna is affected in the second operation mode. The signal performance of the antenna in the first operation mode and the second operation mode can satisfy a preset condition.

Further, the transmission path of the antenna in the first operation mode may include the antenna and a first branch of a circuit coupled to the antenna. The transmission path of the antenna in the second operation mode may include the antenna and a second branch of the circuit coupled to the antenna. Accordingly, in the antenna control method of the present disclosure, along the transmission paths in both operation modes, antenna signals may pass through the antenna. That is, in the present disclosure, through one antenna, the signal performance of the antenna may satisfy the preset condition, by switching the antenna operation mode, i.e., switching the transmission path of the antenna signal. The present disclosure may avoid the certain antenna signal loss caused by a transmission line, which is needed in the existing technology to switch between the top antenna and the bottom antenna of the conventional electronic device.

In some embodiments, the circuit coupled to the antenna may at least include a controller. The operation mode of the antenna may include controlling the transmission path of the antenna signal by the controller. That is, the transmission path of antenna signal can be switched by the controller.

Methods to implement the circuit coupled to the antenna are not restricted in the present disclosure, which may be selected according to various application scenarios.

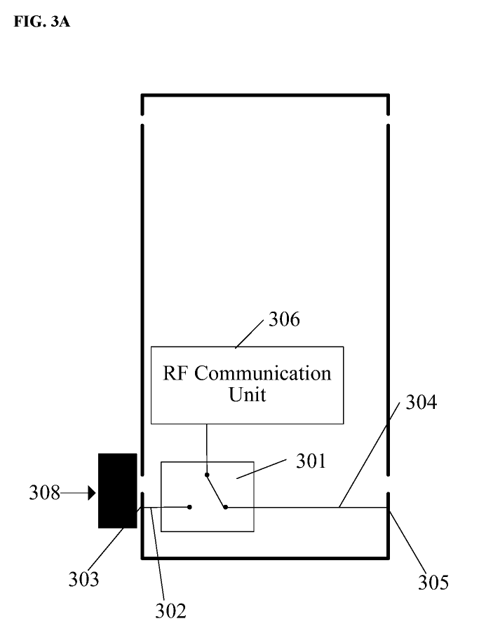

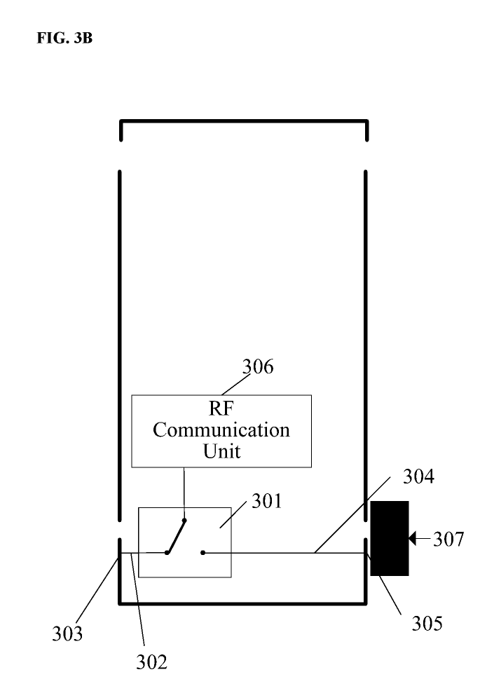

FIGS. 3A and 3B illustrate schematic views of an example of circuit coupled to an antenna according to various disclosed embodiments of the present disclosure. As shown in FIGS. 3A-3B, a controller in the circuit includes a toggle switch 301. The toggle switch 301 is coupled to an antenna signal feed point 303 on a first side of the electronic device via a first branch 302, and is coupled to another antenna signal feed point 305 on a second side of the electronic device via a second branch 304. Further, the toggle switch 301 is coupled to a radio frequency (RF) communication unit 306.

In some embodiments, for the circuit, the antenna signal feed point on an opposite side of a contact side may serve as a present antenna signal feed point for the antenna.

As shown in FIGS. 3A and 3B, the antenna is provided at a bottom of the electronic device, and antenna signal feed points are provided on both sides of the electronic device. When the antenna is in the first operation mode, the toggle switch 301 couples the antenna signal feed point 303 on the first side of the electronic device to the RF communication unit 306. The antenna signal feed point 305 on the second side of the electronic device is uncoupled from, i.e., disconnected from, the RF communication unit 306. That is, the antenna signal can be fed from the antenna signal feed point 303, and transmitted to the RF communication unit 306 via the first branch 302; or a signal provided by the RF communication unit 306 can be transmitted via the first branch 302, and radiated outward through the antenna.

When the antenna is in the second operation mode, the toggle switch 301 couples the antenna signal feed point 305 on the second side of the electronic device to the RF communication unit 306. The antenna signal feed point 303 on the first side of the electronic device is uncoupled from the RF communication unit 306. That is, the antenna signal can be fed from the antenna signal feed point 305, and transmitted to the RF communication unit 306 via the second branch 304; or a signal provided by the RF communication unit 306 can be transmitted via the second branch 304, and radiated outwardly through the antenna.

In some embodiments, a correspondence relationship between the antenna operation mode and the contact information may be preset. For example, the first operation mode may be set to correspond to a right hand contact, and the second operation mode may be set to correspond to a left hand contact. That is, when the antenna is in the first operation mode, the performance of antenna signal may not be affected if a user contacts the electronic device with a right hand, and the performance of antenna signal may be affected if the user contacts the electronic device with a left hand. Similarly, when the antenna is in the second operation mode, if the user contacts the electronic device with a left hand, the performance of antenna signal may not be affected, and the performance of antenna signal may be affected if the user contacts the electronic device with a right hand.

Assume that the antenna is in the first operation mode (not shown in FIG. 3A) before a hand contacts the electronic device. As shown in FIG. 3A, if the user contacts the electronic device with a left hand 308, e.g., if a gap for the antenna signal feed point 303 is in contact with the left hand 308, RF signals transmitted to the antenna signal feed point 303 may be short-circuited by the hand to a non-antenna portion of the frame, resulting in a degradation of the antenna performance. That is, the signal performance of the antenna may be affected and the preset condition may not be satisfied. The signal performance of the antenna being affected when the antenna is in the first operation mode can indicate that the user contacts the electronic device with a left hand. In order to make the antenna performance satisfy the preset condition, the operation mode of the antenna needs to be switched. That is, the operation mode of the antenna needs to be switched from the first operation mode to the second operation mode by the toggle switch 301. In some embodiments, the toggle switch 301 is toggled to electrically uncouple the signal feed point 303 on the left side from the RF communication unit 306, and to electrically couple the antenna signal feed point 305 one the right side to the RF communication unit 306. The status of the circuit after the toggling is shown in FIG. 3A. As shown in FIG. 3A, in the second operation mode, an antenna signal can be fed through the antenna signal feed point 305 at an opposite side of the contact side and transmitted via the second branch 304 to the RF communication unit 306; or a signal provided by the RF communication unit 306 can be transmitted via the second branch 304, and radiated outward through the antenna.

In some embodiments, the correspondence relationship between the antenna operation mode and the contact information may be preset, and the electronic device may include sensors on both sides of the electronic device for detecting whether a user contacts the electronic device with a left hand or a right hand. For example, the first operation mode may be set to correspond to a right hand contact, and the second operation mode may be set to correspond to a left hand contact. When the antenna is in the first operation mode, the sensors on both sides of the electronic device may detect whether a user contacts the electronic device with a left hand or a right hand. If the user contacts the electronic device with a right hand, no switching of the operation mode is needed. If the user contacts the electronic device with a left hand instead of a right hand, the operation mode of the antenna may be switched. That is, the operation mode may be switched from the first operation mode to the second operation mode. Similarly, when the antenna is in the second operation mode, the sensors on both sides of the electronic device may detect whether a user contacts the electronic device with a left hand or a right hand. If the user contacts the electronic device with a left hand, no switching of the operation mode is needed. If the user contacts the electronic device with a right hand instead of a left hand, the operation mode of the antenna may be switched. That is, the operation mode may be switched from the second operation mode to the first operation mode.

Assume that the antenna is in the first operation mode (not shown in FIG. 3A) before a hand contacts the electronic device. As shown in FIG. 3A, the sensor (not shown in FIG. 3A) on the left side of the electronic device detects that the user contacts the electronic device with a left hand 308. In the correspondence relationship, the first operation mode may correspond to the right hand contact and is thus not suitable for the left hand contact shown in FIG. 3A. Therefore, the operation mode of the antenna needs to be switched from the first operation mode to the second operation mode. In some embodiments, the toggle switch 301 can be toggled to electrically uncouple the signal feed point 303 on the left side from the RF communication unit 306, and to electrically couple the antenna signal feed point 305 one the right side to the RF communication unit 306. The status of the circuit after the toggling is shown in FIG. 3A. As shown in FIG. 3A, in the second operation mode, an antenna signal can be fed through the antenna signal feed point 305 at an opposite side of the contact side and transmitted via the second branch 304 to the RF communication unit 306; or a signal provided by the RF communication unit 306 can be transmitted via the second branch 304, and radiated outward through the antenna.

The situation is similar for the antenna in the second operation mode before a hand touches the electronic device.

In some embodiments, assume that the antenna is in the second operation mode (not shown in FIG. 3B) before a hand contacts the electronic device. As shown in FIG. 3B, if the electronic device is in contact with a right hand 307, e.g., if a gap for the antenna signal feed point 305 is in contact with the hand 307, RF signals transmitted to the antenna signal feed point 305 may be short-circuited by the hand to a non-antenna portion of the frame, resulting in degradation of the antenna performance. That is, the antenna signal performance may be affected, and may not meet the preset condition. The antenna signal performance being affected when the antenna is in the second operation mode can indicate that the user contacts the electronic device with a right hand. Because the second operation mode may correspond to the left hand contact and thus may not be suitable for the right hand contact shown in FIG. 3B, the operation mode of the antenna may need to be switched in order to make the performance of the antenna satisfy the preset condition. That is, the operation mode of the antenna may need to be switched from the second operation mode to the first operation mode by the toggle switch 301. In some embodiments, as shown in FIG. 3B, the toggle switch 301 is toggled to electrically uncouple the antenna signal feed point 305 on the contact side from the RF communication unit 306, and to electrically couple the antenna signal feed point 303 on the other side of the contact side to the RF communication unit 306.

In some other embodiments, as shown in FIG. 3B, the sensor (not shown in FIG. 3B) on the right side of the electronic device detects that the user contacts the electronic device with the right hand 307. Assume that the antenna is in the second operation mode (not shown in FIG. 3B) before the hand contacts the electronic device. In the correspondence relationship, the second operation mode may correspond to a left hand contact and is thus not suitable for the right hand contact shown in FIG. 3B. Therefore, the operation mode of the antenna may need to be switched from the second operation mode to the first operation mode. In some embodiments, as shown in FIG. 3B, the toggle switch 301 can be toggled to electrically uncouple the antenna signal feed point 305 on the contact side from the RF communication unit 306, and to electrically couple the antenna signal feed point 303 on the other side of the contact side to the RF communication unit 306.

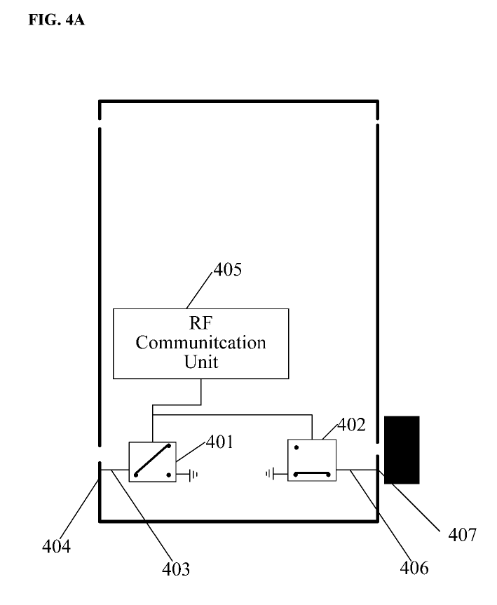

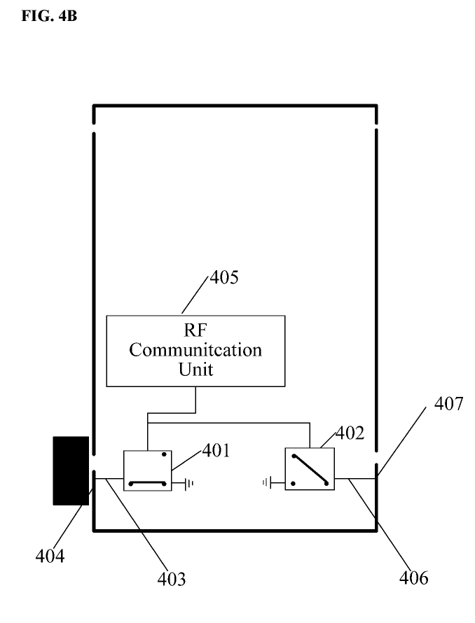

FIGS. 4A and 4B illustrate schematic views of another example of circuit coupled to an antenna according to various disclosed embodiments of the present disclosure. As shown in FIGS. 4A and 4B, a controller in the circuit includes a first toggle switch 401 and a second toggle switch 402. The first toggle switch 401 is coupled to an antenna signal feed point 404 on a first side of the electronic device via a first branch 403 of the circuit, and is coupled to an RF communication unit 405. The second toggle switch 402 is coupled to an antenna signal feed point 407 on a second side of the electronic device via a second branch 406 of the circuit, and coupled to the RF communication unit 405.

For the circuit, the antenna signal feed point on an opposite side of a contact side may serve as a present antenna signal feed point for the antenna.

As shown in FIGS. 4A and 4B, the antenna is provided at a bottom of the electronic device, and both sides of the electronic device each have an antenna signal feed point. When the antenna is in the first operation mode, the first toggle switch 401 controls the antenna signal feed point 404 on the first side of the electronic device to couple to the RF communication unit 405 and to uncouple from a ground, and the antenna signal feed point 407 on the second side of the electronic device is uncoupled from the RF communication unit 405 and coupled to the ground through the second toggle switch 402. That is, antenna signals can be fed from the antenna signal feed point 404, and transmitted to the RF communication unit 405 via the first branch 403; or a signal provided by the RF communication unit 405 can be transmitted via the first branch 403 and radiated outward through the antenna.

When the antenna is in the second operation mode, the second toggle switch 402 controls the antenna signal feed point 407 on the second side of the electronic device to couple to the RF communication unit 405 and to uncouple from the ground, and the antenna signal feed point 404 on the first side of the electronic device is uncoupled from the RF communication unit 405 and coupled to the ground through the first toggle switch 401. That is, antenna signals can be fed from the antenna signal feed point 407, and transmitted to the RF communication unit 405 via the second branch 406; or a signal provided by the RF communication unit 405 can be transmitted via the second branch 406 and radiated outwardly through the antenna.

In some embodiments, a correspondence relationship between the antenna operation mode and the contact information may be preset. For example, the first operation mode may be set to correspond to a right hand contact, and the second operation mode may be set to correspond to a left hand contact. That is, when the antenna is in the first operation mode, the performance of antenna signal may not be affected if a user contacts the electronic device with a right hand, and the performance of antenna signal may be affected if the user contacts the electronic device with a left hand. Similarly, when the antenna is in the second operation mode, if the user contacts the electronic device with a left hand, the performance of antenna signal may not be affected, and the performance of antenna signal may be affected if the user contacts the electronic device with a right hand.

In some embodiments, assume that the antenna is in the second operation mode (not shown in FIG. 4A) before a hand contacts the electronic device. As shown in FIG. 4A, if the user contacts the electronic device with a right hand, e.g., if a gap for the antenna signal feed point 407 is in contact with the hand, RF signals transmitted to the antenna signal feed point 407 may be short-circuited by the hand to a non-antenna portion of the frame, resulting in a degradation of antenna performance. That is, the signal performance of the antenna may be affected and may not satisfy the preset condition. The signal performance of the antenna being affected when the antenna is in the second operation mode can indicate that a user contacts the electronic device with a right hand. In order to make the performance of the antenna satisfy the preset condition, the operation mode of the antenna may need to be switched. That is, the operation mode of the antenna may need to be switched from the second operation mode to the first operation mode by the first toggle switch 401 and the second toggle switch 402. In some embodiments, the antenna signal feed point 404 is coupled to the RF communication unit 405 and uncoupled from a ground through the toggling of the first toggle switch 401, and the antenna signal feed point 407 is uncoupled from the RF communication unit 405 and is coupled to the ground through the toggling of the second toggle switch 402. As shown in FIG. 4A, in the first operation mode, the antenna signal can be fed through the antenna signal feed point 404 on the other side of the contact side and transmitted to the RF communication unit 405 via the first branch 403; or a signal provided by the RF communication unit 405 can be transmitted via the branch 403, and radiated outward through the antenna.

In some embodiments, the correspondence relationship between the antenna operation mode and the contact information may be preset, and the electronic device may include sensors on both sides of the electronic device for detecting whether a user contacts the electronic device with a left hand or a right hand. For example, the first operation mode may be set to correspond to a right hand contact, and the second operation mode may be set to correspond to a left hand contact. When the antenna is in the second operation mode, the sensors on both sides of the electronic device may detect whether a user contacts the electronic device with a left hand or a right hand. If the user contacts the electronic device with a left hand, no switching of the operation mode is needed. If the user contacts the electronic device with a right hand instead of a left hand, the operation mode of the antenna may be switched to the first operation mode. When the antenna is in the first operation mode, the sensors on both sides of the electronic device may detect whether a user contacts the electronic device with a left hand or a right hand. If the user contacts the electronic device with a right hand, no switching of the operation mode is needed. If the user contacts the electronic device with a left hand instead of a right hand, the operation mode of the antenna may be switched to the second operation mode.

In some embodiments, assume that the antenna is in the second operation mode (not shown in FIG. 4A) before a hand contacts the electronic device. As shown in FIG. 4A, a sensor (not shown in FIG. 4A) on the right side of the electronic device detects that the user contacts the electronic device with a right hand. In the correspondence relationship, the second operation mode may correspond to the left hand contact and is thus not suitable for the right hand contact shown in FIG. 4A. Therefore, the operation mode of the antenna may need to be switched from the second operation mode to the first operation mode by toggling the toggle switch 401 and the toggle switch 402. The status of the circuit after the toggling is shown in FIG. 4A. As shown in FIG. 4A, in the first operation mode, the antenna signal can be fed through the antenna signal feed point 404 on the other side of the contact side and transmitted to the RF communication unit 405 via the first branch 403; or a signal provided by the RF communication unit 405 can be transmitted via the branch 403, and radiated outward through the antenna.

The situation is similar for the antenna in the first operation mode before a hand touches the electronic device.

In some embodiments, assume that the antenna is in the first operation mode (not shown in FIG. 4B) before a hand contacts the electronic device. As shown in FIG. 4B, if the electronic device is in contact with a left hand, e.g., if a gap for the antenna signal feed point 404 is in contact with the hand, RF signals transmitted to the antenna signal feed point 404 may be short-circuited by the hand to a non-antenna portion of the frame, resulting in a degradation of antenna performance. That is, the antenna signal performance may be affected, and may not satisfy the preset condition. The antenna signal performance being affected when the antenna is in the first operation mode can indicate that a user contacts the electronic device with a left hand. Because the first operation mode may correspond to the right hand contact and thus may not be suitable for the left hand contact shown in FIG. 4B, the operation mode of the antenna may need to be switched in order to make the performance of the antenna satisfy the preset condition. Accordingly, the electronic device may generate a first switching signal. By toggling the first toggle switch 401 and the second toggle switch 402, the operation mode of the antenna may be switched from the first operation mode to the second operation mode. In some embodiments, as shown in FIG. 4B, the antenna signal feed point 404 is uncoupled from the RF communication unit 405 and is coupled to the ground through the first toggle switch 401; and the antenna signal feed point 407 is coupled to the RF communication unit 405 and uncoupled from the ground through the second toggle switch 402.

In some other embodiments, as shown in FIG. 4B, a sensor (not shown in FIG. 4B) on the left side of the electronic device may detect that the user contacts the electronic device with a left hand. Assume that the antenna is in the first operation mode (not shown in FIG. 4B) before the hand contacts the electronic device. In the correspondence relationship, the first operation mode may correspond to a right hand contact and is thus not suitable for the left hand contact shown in FIG. 4B. Therefore, the operation mode of the antenna may need to be switched to the second operation mode. In some embodiments, as shown in FIG. 4B, the antenna signal feed point 404 is uncoupled from the RF communication unit 405 and is coupled to the ground through the first toggle switch 401; and the antenna signal feed point 407 is coupled to the RF communication unit 405 and uncoupled from the ground through the second toggle switch 402.

In the present disclosure, using one antenna, the antenna operation mode may be switched by switching the antenna signal feed point according to how the electric device is in contact with a user, to ensure that the signal performance of the antenna continues to satisfy a preset condition. In the present disclosure, because only one antenna is needed, an RF transmission line may not be needed, as compared to the scheme of switching between the bottom antenna and the top antenna in the conventional technology. Accordingly, in the present disclosure, no signal loss due to the RF transmission line may exist. In addition, because the antenna may be provided at the bottom of the electronic device and relatively far from a user's head, the amount of radiation from the electronic device may not be excessive to the human brain, facilitating a protection of human health. Further, because the antenna may be provided at the bottom of the electronic device, an influence of the user's head on the antenna signal performance may not be large even when the user uses the electronic device close to the user's head.

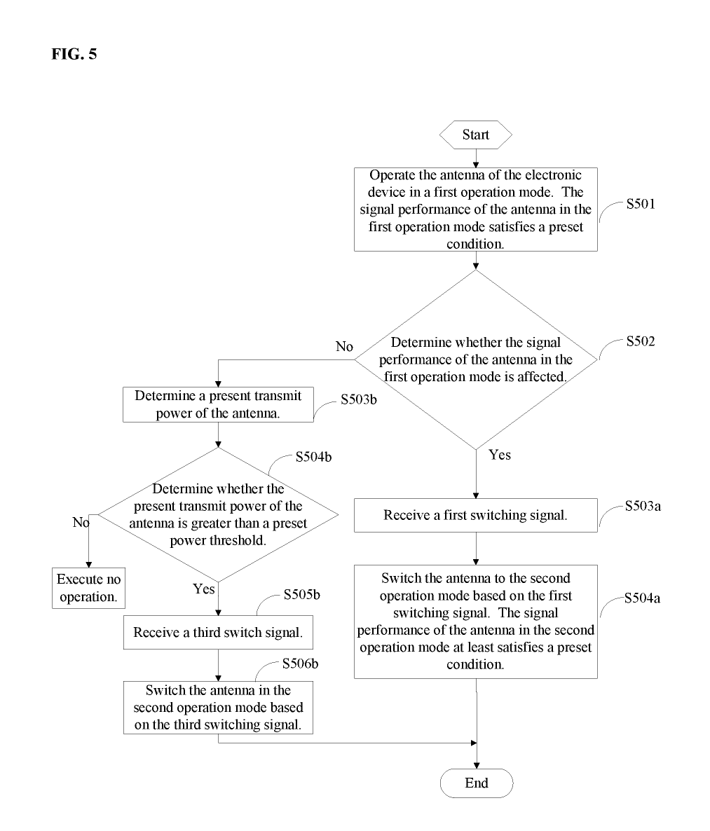

A maximum antenna radiation energy may generally concentrate at a certain position near the antenna and the antenna radiation energy may be absorbed by the human body for a period of time. In order to reduce the amount of radiation absorbed by the human body, the present disclosure provides another antenna control method. The antenna control method may reduce the radiation of the electronic device to the human brain by dispersing antenna radiation energy previously concentrated in one region. FIG. 5 illustrates a flow chart of another example of antenna control method according to various disclosed embodiments of the present disclosure. With reference to FIG. 5, the antenna control method will be described now.

At S501, the antenna of the electronic device is operated in a first operation mode.

The signal performance of the antenna in the first operation mode satisfies a preset condition.

At S502, whether or not the signal performance of the antenna in the first operation mode is affected is determined.

At S503a, if the signal performance in the first operation mode is affected, a first switching signal is received, and then S504a is executed.

At S504a, the antenna is switched to a second operation mode based on the first switching signal.

The signal performance of the antenna in the second operation mode at least satisfies the preset condition.

A transmission path of the antenna signal may include a first transmission path and a second transmission path. The first transmission path may include the antenna and a first branch of a circuit coupled to the antenna. The second transmission path may include the antenna and a second branch of the circuit. The antenna signal is transmitted along the first transmission path in the first operation mode. The antenna signal is transmitted along the second transmission path in the second operation mode.

In order to reduce the radiation of the electronic device to the human brain, radiation energy of the antenna previously concentrated in one region may be dispersed. A technical solution of the present disclosure will be described now.

At S503b, a present transmit power of the antenna is determined if the signal performance of the antenna in the first operation mode is not affected.

In some embodiments, the present transmit power of the antenna is determined via a baseband signal.

At S504b, whether the present transmit power of the antenna is greater than a preset power threshold is determined.

At S505b, if the present transmit power of the antenna is greater than the preset power threshold, a third switching signal is received.

At S506b, the antenna is switched to the second operation mode based on the third switching signal.

If the present transmit power of the electronic device is greater than the preset power threshold, under a premise that the signal performance of the antenna satisfies the preset condition, the operation mode of the antenna may be switched, such that the radiation energy of the antenna may be dispersed.

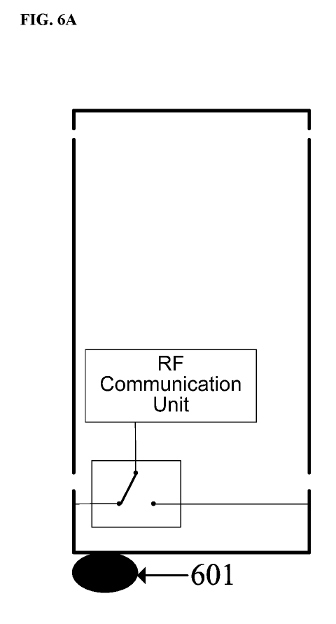

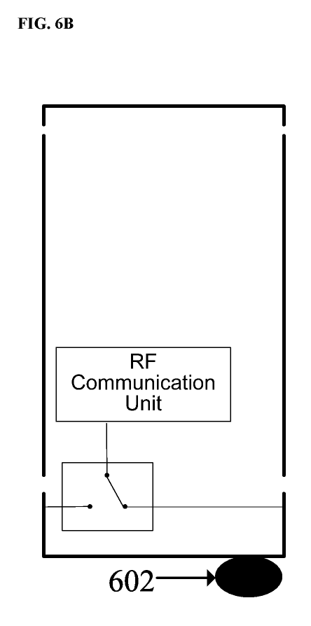

In some embodiments, with reference to FIG. 6A, if the antenna is in the first operation mode and antenna signals are fed from the left antenna signal feed point, a maximum antenna radiation energy appears at a region 601 on the left side. With reference to FIG. 6B, if the antenna is switched to the second operation mode, the antenna signal is fed from the antenna signal feed point on the right side, and the maximum antenna radiation energy appears at a region 602 on the right side. Thus, under the premise that the signal performance of the antenna satisfies the preset condition, by switching the antenna operation mode, the maximum antenna radiation energy appears in two different regions. Accordingly, the antenna radiation energy previously concentrated in one region is distributed into two regions to reduce the antenna radiation on the human brain.

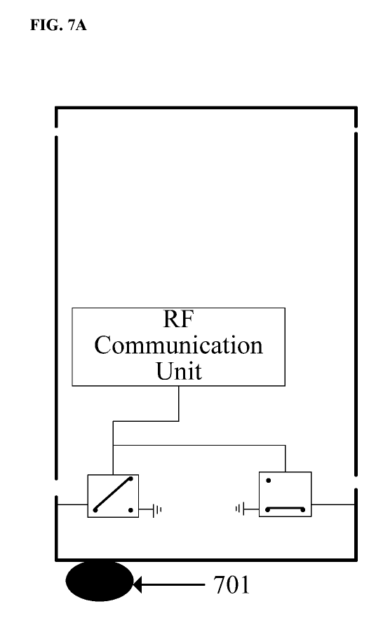

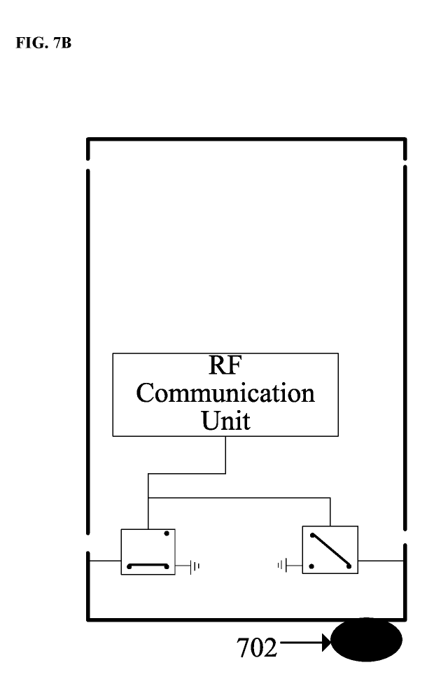

In some embodiments, with reference to FIG. 7A, if the antenna is in the first operation mode, the antenna signal is fed from the antenna signal feed point on the left side, and the maximum antenna radiation energy appears in a region 701 on the left side. With reference to FIG. 7B, if the antenna is switched to the second operation mode, the antenna signal is fed from the right antenna signal feed point, and the maximum antenna radiation energy appears in a region 702 on the right side. Thus, under a premise that the signal performance of the antenna satisfies the preset condition, by switching the antenna operation mode, the maximum antenna radiation energy appears in two different regions. Accordingly, the antenna radiation energy previously concentrated in one region is distributed into two regions to reduce the antenna radiation on the human brain.

The antenna control method of the disclosure can operate an antenna of an electronic device in a first operation mode, receive a first switching signal if the signal performance of the antenna is affected in the first operation mode, and then switch the operation mode of the antenna from the first operation mode to the second operation mode after the first switching signal is received. Further, by the antenna control method of the disclosure, when the signal performance of the antenna is not affected in the first operation mode, the operation mode of the antenna can be switched from the first operation mode to the second operation mode if the transmit power of the antenna is greater than the preset power threshold.

Thus, in the antenna control method of the disclosure, if the signal performance of the antenna in the present operation mode is affected, the switching of the operation mode may be performed to ensure that the signal performance of the antenna satisfies a preset condition. When the signal performance in the present operation mode is not affected, in order to reduce the radiation of the antenna to the human body, the operation mode can also be switched, such that the maximum antenna radiation energy may appear in two different regions. As a result, the antenna radiation energy may be dispersed, and the radiation of the antenna to the human body may be reduced.

In the antenna control method of the present disclosure, only one antenna is needed. By switching the antenna operation mode, not only the signal performance of the antenna can satisfy a preset condition, but also the radiation of the antenna to the human body can be reduced, under the premise that the signal performance of the antenna satisfies the preset condition.

The present disclosure also provides an electronic device. The electronic device may at least include a sensor and a controller.

The controller may be used to operate an antenna of the electronic device in the first operation mode. The signal performance of the antenna in the first operation mode may satisfy a preset condition.

The sensor may be used to receive a first switching signal.

The controller may be further used to switch the antenna to the second operation mode based on the first switching signal. The signal performance of the antenna in the second operation mode may at least satisfy the preset condition.

A transmission path of the antenna signal may include a first transmission path and a second transmission path. The first transmission path may include the antenna and a first branch of a circuit coupled to the antenna. The second transmission path includes the antenna and a second branch of the circuit. The antenna signal is transmitted along the first transmission path in the first operation mode. The antenna signal is transmitted along the second transmission path in the second operation mode.

The electronic device of the disclosure can operate the antenna in the first operation mode, and switch the operation mode of the antenna from the first operation mode to the second operation mode after the first switching signal is received. The signal performance of the antenna in the first operation mode and the second operation mode can satisfy the preset condition. Further, a transmission path of the antenna in the first operation mode may include the antenna and a first branch of a circuit coupled to the antenna. A transmission path of the antenna in the second operation mode may include the antenna and a second branch of the circuit coupled to the antenna. In the electronic device of the present disclosure, along the transmission paths of the antenna signal in both operation modes, antenna signals may pass through the antenna. That is, in the electronic device of the present disclosure, through one antenna, the signal performance of the antenna can satisfy the preset condition, by switching the antenna operation mode, i.e., switching the transmission path of the antenna signal. The electronic device of the present disclosure may avoid the certain signal loss caused by a transmission line, which is needed in the existing technology to switch between a top antenna and a bottom antenna of a conventional electronic device.

In the electronic device of the present disclosure, the sensor may be further used to receive a second switching signal after the controller switches the antenna to the second operation mode.

The controller may be further used to control the antenna to be in the first operation mode based on the second switching signal.

In the electronic device of the present disclosure, the circuit coupled to the antenna may at least include a controller. The operation mode may include controlling the transmission path of the antenna signal by the controller.

In the electronic device of the disclose, the sensor may be used to determine whether or not the signal performance of the antenna in the first operation mode is affected, and if the signal performance of the antenna in the first operation mode is affected, the first switching signal is received.

In some embodiments, when the antenna of the electronic device is in the second operation mode, the antenna signal feed point on the opposite side of the contact side may serve as a present antenna signal feed point of the antenna.

In some embodiments, with reference to FIGS. 3A and 3B, the controller includes a toggle switch. The toggle switch is coupled to an antenna signal feed point on one side of the electronic device via a first branch, coupled to an antenna signal feed point on the other side of the electronic device via a second branch, and coupled to an RF communication unit.

The toggle switch may be used to uncouple the antenna signal feed point on the contact side from the RF communication unit, and couple the antenna signal feed point on the other side of the contact side to the RF communication unit, based on a first switching signal.

The toggle switch may be used to uncouple the antenna signal feed point on the contact side from the RF communication unit, and couple the antenna signal feed point on the other side of the contact side to the RF communication unit, based on a second switching signal.

In some other embodiments, when the antenna of the electronic device is in the second operation mode, the antenna signal feed point on the other side of the contact side may serve as a present antenna signal feed point of the antenna.

With reference to FIGS. 4A and 4B, the controller includes a first toggle switch and a second toggle switch. The first toggle switch is coupled to the antenna signal feed point on one side of the electronic device via the first branch, and coupled to the RF communication unit. The second toggle switch is coupled to the antenna signal feed point on the other side of the electronic device via the second branch, and coupled to the RF communication unit.

The first toggle switch and the second toggle switch may be used to control the antenna signal feed point on the contact side to uncouple from the RF communication unit and to couple to the ground, and used to control the antenna signal feed point on the other side of the contact side to couple to the RF communication unit, and to uncouple from the ground.

In some embodiments, the electronic device may further include a processor.

The processor may be used to determine a present transmit power when the signal performance of the antenna in the first operation mode is not affected, to determine whether the present transmit power of the antenna is greater than a preset power threshold, and to receive a third switching signal if the present transmit power of the antenna is greater than the preset power threshold.

The controller may be further used to switch the antenna to the second operation mode based on the third switching signal.

The present disclosure provides an antenna control method and an electronic device. The antenna control method may include operating an antenna of the electronic device in a first operation mode, where a signal performance of the antenna in the first operation mode may satisfy a preset condition; receiving a first switching signal; switching the antenna of the electronic device to a second operation mode based on the first switching signal, where a signal performance of the antenna in the second operation mode may at least maintain satisfying the preset condition. Further, in the first operation mode, an antenna signal may be transmitted in the first transmission path. In the second operation mode, the antenna signal may be transmitted in a second transmission path. The first transmission path may include the antenna and a first branch of a circuit coupled to the antenna. The second transmission path may include the antenna and a second branch of the circuit coupled to the antenna. In the present disclosure, through one antenna, the signal performance of the antenna may satisfy a preset condition, by switching the antenna operation mode. The present disclosure may avoid the certain antenna signal loss caused by a transmission line. The transmission line may be needed in the existing technology to switch between the top antenna and the bottom antenna of the conventional electronic device.

In the above embodiments, as examples, the first operation mode is described as corresponding to the right hand contact with the antenna signal feed point on the left side of the electronic device coupled to the RF communication unit and the antenna signal feed point on the right side of the electronic device uncoupled from the RF communication unit. Similarly, the second operation mode is described as corresponding to the left hand contact with the antenna signal feed point on the left side of the electronic device uncoupled from the RF communication unit and the antenna signal feed point on the right side of the electronic device coupled to the RF communication unit. In some other embodiments, the correspondence relationship and coupling scheme can be different from those described in the disclosure. For example, the first operation mode can correspond to the left hand contact and the second operation mode can correspond to the right hand contact.

In the specification, various embodiments are described by a progressive manner, and various embodiments are described with focuses on different aspects as compared to other embodiments. The same or similar portions between the various embodiments can be referred to each other.

In embodiments of the present disclosure, it should be understood that, the disclosed methods, apparatus, and devices may be implemented in other ways. For example, the described apparatus embodiments are merely for illustrative purposes. For example, the unit division is merely logical function division, and there may be other division in actual implementation. For example, a plurality of units or components may be combined or can be integrated into another system, or some features may be ignored or not performed. In addition, displayed or discussed coupling or direct coupling or communication connection between each other may be indirect coupling or communication connection via some communication interface, device, or unit, and may be in electrical, mechanical, or another form.

The units that are described as separated parts may be or may not be physically separated, parts displayed as units may be or may not be physical units, i.e., may be located in one place, or may be distributed to multiple network units. Some or all of the units can be selected according to actual needs to achieve the object of the solutions of the embodiments. Further, the functional units in the embodiments of the present disclosure can be integrated into one unit or may physically exist as separate units, or two or more units may be integrated into one unit.

In the present disclosure, the functions described above may be implemented as an independent product sold or used in the form of a software functional module, which may be stored in a computer-readable storage medium. Based on such understanding, the technical solutions of the embodiments of the present disclosure, or the parts contributing to the existing technology, or part of the technical solutions may be embodied in a software product, which may be stored in a storage medium and include several instructions to enable a computer device (may be a personal computer, a server, or network device) to execute all or part of a method consistent with embodiments of the present disclosure, such as one of the examples of methods described above. The storage medium may include a universal serial bus (USB) disk, a mobile hard disk, a read-only memory (ROM), a random access memory (RAM), a magnetic disk, an optical disk, or another appropriate medium that may store program codes.

The foregoing description of the embodiments of the disclosure has been presented for purposes of illustration and description. It is not intended to be exhaustive or to limit the disclosure to the precise form or to the embodiments disclosed. Accordingly, the foregoing description should be regarded as illustrative rather than restrictive. Obviously, many modifications and variations will be apparent to persons skilled in this art. The embodiments are chosen and described in order to explain the principles of the technology, with various modifications suitable to the particular use or implementation contemplated. It is intended that the scope of the invention be defined by the claims appended hereto and their equivalents in which all terms are meant in their broadest reasonable sense unless otherwise indicated. Therefore, the term “the disclosure,” “the present disclosure,” or the like does not necessarily limit the claim scope to a specific embodiment, and the reference to embodiments of the disclosure does not imply a limitation on the invention, and no such limitation is to be inferred. Moreover, the claims may refer to “first,” “second,” etc., followed by a noun or element. Such terms should be understood as a nomenclature and should not be construed as giving the limitation on the number of the elements modified by such nomenclature unless specific number has been given. Any advantages and benefits described may or may not apply to all embodiments of the disclosure. It should be appreciated that variations may be made to the embodiments described by persons skilled in the art without departing from the scope of the present disclosure. Moreover, no element or component in the present disclosure is intended to be dedicated to the public regardless of whether the element or component is explicitly recited in the following claims.

What is claimed is:

1. A method comprising:
operating an antenna of an electronic device in a first operation mode, wherein the electronic device uses a first transmission path for transmitting antenna signals, the first transmission path including the antenna and a first branch of a circuit coupled to the antenna;
receiving a switching signal; and
switching the antenna to a second operation mode based on the switching signal, wherein the electronic device uses a second transmission path for transmitting the antenna signals, the second transmission path including the antenna and a second branch of the circuit.

2. The method according to claim 1,
wherein the switching signal is a first switching signal,
the method further comprising:
receiving a second switching signal after the antenna is switched to the second operation mode; and
switching the antenna to the first operation mode based on the second switching signal.

3. The method according to claim 1, wherein receiving the switching signal includes:
determining whether a signal performance of the antenna in the first operation mode is affected; and
receiving the switching signal if the signal performance of the antenna in the first operation mode is affected.

4. The method according to claim 3, wherein:
determining whether the signal performance of the antenna in the first operation mode is affected includes determining whether an antenna signal feed point coupled to the first transmission path is in contact with a hand, and
switching the antenna to the second operation mode includes switching to an antenna signal feed point coupled to the second transmission path for signal feeding.

5. The method according to claim 1, wherein:
the electronic device includes:
a radio frequency (RF) communication unit;
a toggle switch electrically coupled to the RF communication unit;
a first antenna signal feed point coupled to the first branch; and
a second antenna signal feed point coupled to the second branch, and
switching the antenna to the second operation mode includes toggling the toggle switch to uncouple the first antenna signal feed point from the RF communication unit and to couple the second antenna signal feed point to the RF communication unit.

6. The method according to claim 1, wherein:
the electronic device includes:
a radio frequency (RF) communication unit;
a first toggle switch electrically coupled to the RF communication unit;
a second toggle switch electrically coupled to the RF communication unit;
a first antenna signal feed point coupled to the first branch; and
a second antenna signal feed point coupled to the second branch, and
switching the antenna to the second operation mode includes:
toggling the first toggle switch to uncouple the first antenna signal feed point from the RF communication unit and to couple to a ground, and
toggling the second toggle switch to couple the second antenna signal feed point to the RF communication unit and to uncouple from the ground.

7. The method according to claim 1, further comprising:
determining whether a signal performance of the antenna in the first operation mode is affected;
determining a transmit power of the antenna if the signal performance of the antenna in the first operation mode is not affected; and
determining whether the transmit power of the antenna is greater than a power threshold,
wherein receiving the switching signal includes receiving the switching signal if the transmit power of the antenna is greater than the power threshold.

8. An electronic device comprising:
an antenna;
a circuit coupled to the antenna, wherein the circuit includes a first branch and a second branch;
a sensor, wherein the sensor receives a switching signal; and
a controller coupled to the antenna, wherein the controller switches the antenna from a first operation mode to a second operation mode based on the switching signal,
wherein:
in the first operation mode, a first transmission path including the antenna and the first branch is used for transmitting antenna signals, and
in the second operation mode, a second transmission path including the antenna and the second branch is used for transmitting antenna signals.

9. The electronic device according to claim 8, wherein:
the switching signal is a first switching signal,
the sensor further receives a second switching signal after the controller switches the antenna to the second operation mode, and
the controller further switches the antenna to the first operation mode based on the second switching signal.

10. The electronic device according to claim 8, wherein the sensor further:
determines whether a signal performance of the antenna in the first operation mode is affected, and
receives the switching signal if the signal performance of the antenna in the first operation mode is affected.

11. The electronic device according to claim 10, further comprising:
a first antenna signal feed point coupled to the first branch; and
a second antenna signal feed point coupled to the second branch.

12. The electronic device according to claim 11, further comprising:
a radio frequency (RF) communication unit,
wherein:
the controller includes a toggle switch coupled to the RF communication unit, and
the controller switches the antenna from the first operation mode to the second operation mode by toggling the toggle switch to uncouple the first antenna signal feed point from the RF communication unit and to couple the second antenna signal feed point to the RF communication unit.

13. The electronic device according to claim 11, further comprising:
a radio frequency (RF) communication unit,
wherein:
the controller includes:
a first toggle switch electrically coupled to the first antenna signal feed point and electrically coupled to the RF communication unit; and
a second toggle switch electrically coupled to the second antenna signal feed point and electrically coupled to the RF communication unit, and
the controller switches the antenna from the first operation mode to the second operation mode by:
toggling the first toggle switch to uncouple the first antenna signal feed point from the RF communication unit and to couple the first antenna signal feed point to a ground, and
toggling the second toggle switch to couple the second antenna signal feed point to the RF communication unit and to uncouple the second antenna signal feed point from the ground.

14. The electronic device according to claim 8,
wherein the switching signal is a first switching signal,
the electronic device further comprising:
a processor coupled to the controller, wherein the processor:
determines a transmit power of the antenna in response to that a signal performance of the antenna in the first operation mode is not affected,
determines whether the transmit power of the antenna is greater than a power threshold, and
receives a second switching signal if the transmit power of the antenna is greater than the power threshold,
wherein the controller further switches the antenna to the second operation mode based on the second switching signal.
